(19) United States
(12) Patent Application Publication
(10) Pub. No.: US 2002/0067340 A1
(43) Pub. Date: Jun. 6, 2002

(54) Method and apparatus for shorthand processing of medical images, wherein mouse positionings and/or actuations will immediately control image measuring functionalities, and a pertinent computer program

(76) Inventor: Filips Van Liere, Eindhoven (NL)

Correspondence Address: U.S. Philips Corporation, 580 White Plains Road, Tarrytown, NY, 10591, US

(21) Appl. No.: 09/864,107

(22) Filed: May 24, 2001

(30) Foreign Application Priority Data
May 24, 2000 (EP) 00201840.6

(51) Int. Cl. G09G 5/08

(52) U.S. Cl. 345/157

(57) ABSTRACT

Cursor-based interaction on a computer-displayed medical image produces graphics related to information in the images in which successive locator positionings and/or actuations control both the geometry and the type of the graphics object. In particular, the state of the interaction is used to distinguish what type of graphics object is required. Various types of measurements are effected.

### BACKGROUND OF THE INVENTION

The invention relates to a method as recited in the preamble of claim 1. A prior art problem is often the excessive mouse travel required to activate functions. For example, an image measurement operation activated through a button on a toolbar may go as follows:

1. Move cursor to button on toolbar

2. Click on button to activate measurement function.

3. Move cursor over image

4. Perform graphics creation interaction on image.

Steps 1, 2 and 3 are required because a toolbar button must be pressed prior to graphics creation. In particular when performing multiple operations on images, continual cursor movements to and from menu-bars, toolbars and/or control panels become a nuisance. In the present invention, measurements may be made directly on the image so that the cursor need not travel to an edge of the image.

The distraction from on-screen toolbars and control panels increases with the amount of screen area reserved to such user interface constructs. Workstation screen area is scarce and should better be dedicated to essential information. For routine and diagnostic viewing this is displaying medical images. The invention does not rely on user interface constructs other than an on-screen region to display an image and associated graphics overlays.

The invention is based on an interaction model for routine medical image display, such as may be produced by CT, MRI, and various other present and future technologies. Particular features pertain to display, measurement and annotation functions for the image. Known organizations have many user interface items, such as icons, bars, and other. The present invention features in particular single mouse-button interactions. A few operations may use modifier keys. Most manipulations will directly affect images and associated overlay graphics. Control panels may be used to set preferences or default behaviour. Such control panels may be activated by pop-up menus. A few advanced applications augment the basic interactions by menus, toolbars or control panels. The model can comprehensively access viewing operations, such as in particular image measurements and image annotations.

### SUMMARY TO THE INVENTION

In consequence, amongst other things, it is an object of the present invention to provide inherent manipulation of the images, without necessitating overlay items that would obscure the image. Now therefore, according to one of its aspects the invention is characterized according to the characterizing part of claim 1.

The invention also relates to an apparatus that is arranged for implementing a method as claimed in claim 1, and to a machine readable computer program for implementing a method as claimed in claim 1. Feasible transfer media would be Internet and various types of data carriers, such as floppy disks. Further advantageous aspects of the invention are recited in dependent claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a medical imaging arrangement;

FIG. 2, an applicable image field;

FIG. 3, a pixel value measurement principle;

FIG. 4, a line measurement principle;

FIG. 5, an angle value measurement principle;

FIG. 6, a poly-line region-of-interest measurement principle;

FIG. 7, a freehand region-of-interest measurement principle;

FIG. 8, a poly-line curve measurement principle;

FIG. 9, a freehand measurement principle.

### DETAILED DESCRIPTION OF PREFERRED EMBODIMENTS

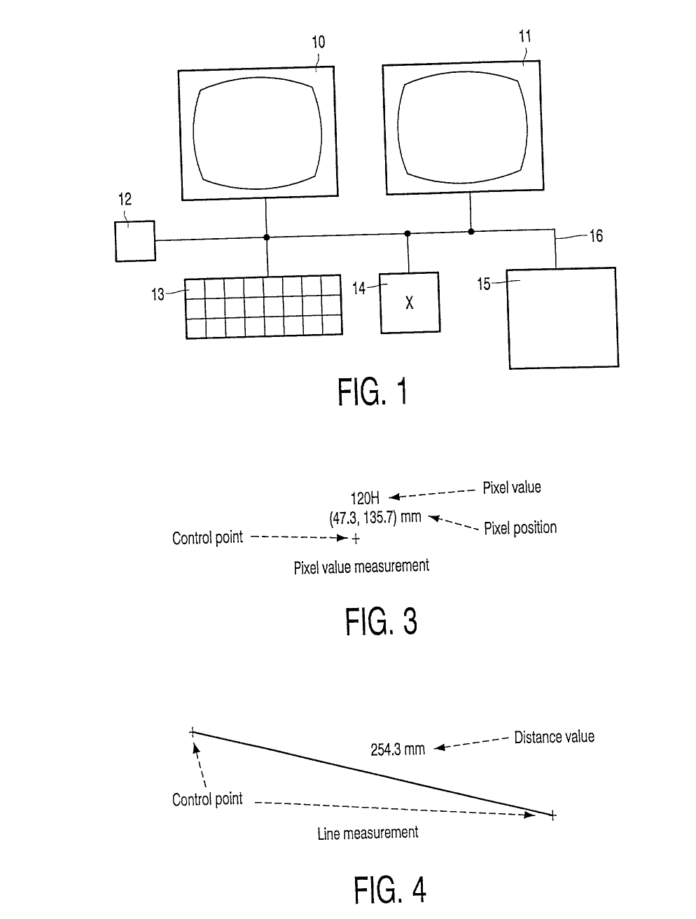

FIG. 1 shows a medical imaging arrangement as pertaining to one or more conventional imaging technologies, such as CT, MRI, or other. The arrange has two image monitors 10, 11, a keyboard 13, mouse 14, and a processor provided with appropriate storage 15. All these subsystems are interconnected through a suitable interconnection facility 16 that can be bus-based. I/O facility 12 interconnects to an outer world for receiving image data derived from the detection subsystem not shown for brevity, and for outputting of processed image data for long-term storage, hardcopying, and other. A user person may manipulate the image in various manners described hereinafter through mouse and/or keyboard actuations. Various other system configurations would be obvious to a person skilled in the art of image manipulating systems.

The invention uses simple mouse control: operation is foremostly controlled by a pointing device and a single button, sometimes enhanced by accelerators and/or modifiers. The invention is commonly comprehensive: it provides access to standard operations, but does not rule out any particular operation and may be adapted to specific requirements. The invention features the following operations:

| Operation | Description |
|---|---|
| Point | Pixel value measurements |
| Distance | Distance and pixel value profile measurements |
| Angle | Angle measurements |
| Region-of-interest | Area & pixel value statistics measurements |
| Annotation | Anchored and pointed image annotations |

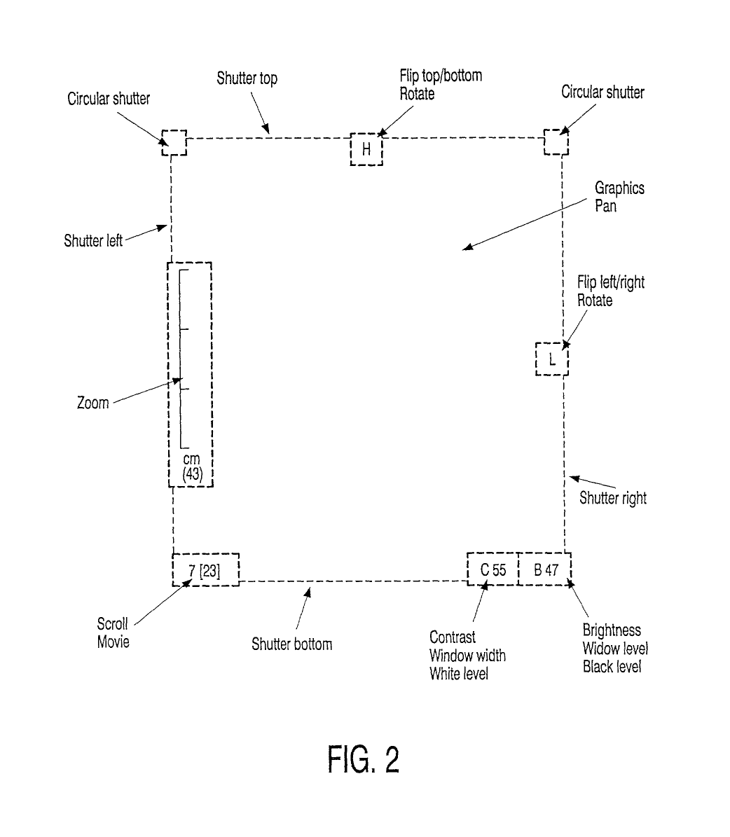

These represent various operations on images without basically amending the image itself. Now, FIG. 2 illustrates an image field, wherein various sensitive areas have been indicated as disclosed more in particular in the companion patent application PHNL000279EPP (ref.: ) that is herein incorporated by reference.

Since the present invention does not need screen area for extraneous user-interface constructs, diagnostic-viewing applications will emulate a conventional light-box by using screen area predominantly for image display.

Simple operation is essential for seldom-used applications. Many users get confused in a more complex environment. Providing a system controlled only by a mouse is motivated in that virtually all systems running viewing applications have a mouse which is a very cost effective device. However, other devices such as graphics tablets are feasible as well. The invention uses incremental graphics creation in that graphics objects associated with measurements and annotations are created by incrementally extending them to increasingly involved objects. These design principles are discussed further hereinafter.

Many applications provide graphics through toolbars with buttons dedicated to creating specific types of graphics objects. This approach suffers from being modal and interaction restricts to creating a single type of graphics object. Creating multiple types of graphics objects requires much mouse travel, moving the cursor to and from the toolbar.

Graphics objects used for measurements during routine viewing such as points, lines, angles and contours can be seen as being constructed from a sequence of points or drawn curves. This gives an incremental approach to graphics creation. A line is constructed from a point by adding a point, adding a point to a line forms an angle and a curve or contour is formed by entering a sequence of points. The type of graphics object being created is not defined up front but deduced from the number and or/topology of points entered during its creation. This avoids a modal interface since only one interaction creates all graphics objects.

Now, basic mouse interactions take one of two styles:

Click-Move-Click—The interaction is performed while no mouse button is pressed.

Press-Drag-Release—The interaction is performed while a mouse button is pressed.

Of these, the click-move-click style has the advantage that the actual mouse motion is performed without a mouse button being pressed, such enabling a finer control. The -press-drag-release style has the advantage that fewer mouse clicks are required.

Click-Move-Click

1. Move cursor to interaction position. Appropriate cursor displayed

2. Click mouse button. Optionally with one or more modifier keys.

3. Move cursor over screen. Interaction takes place.

4. Click mouse button.

Press-Drag-Release

1. Move cursor to interaction position. Appropriate cursor displayed.

2. Press mouse button. Optionally with one or more modifier keys.

3. Drag cursor over screen. Interaction takes place.

4. Release mouse button.

Which interaction actually takes place depends on the position at which the mouse interaction is initiated and which mouse buttons and modifier keys are pressed. The further disclosure presents the click-move-click style of mouse interaction. All interactions can be straightforwardly converted to the press-drag-release style.

Graphics

The following measurements and annotations are most common in diagnostic image viewing:

Point measurement measures the pixel-value and position of a selected point on the image.

Line measurement measures a distance between two selected points on an image, and optionally the pixel-value profile of the image along the line defined by the two points in a chart.

Angle measurement measures the angle formed by three selected points on the image and the distance between the successive pairs of points.

Curve measurement measures the distance along a curve drawn over the image. The curve may be drawn by hand or defined as a series of points connected by lines. Optionally, this can also display the pixel-value profile of the image along the curve in a chart.

Region-of-interest measurement finds the area and various pixel-value statistics of an image region. Optionally, this can display the pixel-value histogram of the region in a chart.

Anchored annotation displays a text annotation at a specific position on the image.

Pointed annotation displays a text with an arrow pointing at a specific point in the image.

Measurements and annotations are collectively called graphics. A specific graphic is either a measurement or an annotation. All graphics interactions are performed using a single mechanism. The basic interaction has the following steps:

1. Move cursor to first point position.

2. Click with shift modifier to mark first point on image.

3. Move cursor to next point on image.

4. Click to mark next point on image.

5. Repeat steps 3 and 4 to define measurement graphic.

6. Type text to enter annotation.

7. Click to finish interaction.

Steps 3, 4 and 5 are only required if the graphics consist of multiple points. Step 6 is only required for defining an annotation. The graphics type of depends on the number of points used during the interaction, and on whether or not annotation text was entered, as illustrated by the following table:

| Number of Points | | Text | Shape | Graphic |
|---|---|---|---|---|
| | 1 | No | Open | Point |
| | 2 | No | Open | Line |
| | 3 | No | Open | Angle |
| | 4 . . . N | No | Open | Curve |
| | 4 . . . N | No | Closed | Region-of-interest |
| | 1 | Yes | Open | Anchored annotation |
| | 2 . . . N | Yes | Open | Pointed annotation |

In the interaction model the user need not define what type of graphic is intended. The type is given by the actual interaction performed. This simplifies graphics creation by reducing the number of interactions and the amount of mouse travel. The following describes various graphic and detail typical interactions associated with their creation. The complete interaction model including various options is also presented.

FIG. 3 represents a pixel value measurement principle, wherein point measurements measure pixel values and positions at selected points in the image. For images wherein pixel values are calibrated, such as CT images, the pixel value is displayed in the corresponding pixel value scale. For non-calibrated pixel values, the pixel code value, often an unsigned integer value, is displayed. Images wherein distance is calibrated, such as CT and MR images or explicitly calibrated RF images, display the measurement position in millimeter coordinates. Non-distance-calibrated images display a measured position in pixel coordinate units. The interaction is as follows:

1. Move cursor to point position; Cross Hair cursor is displayed.

2. Click with shift modifier to mark point on image. Pixel-value and position displayed.

3. Click to finish interaction.

Options are as follows.

| | |
|---|---|
| Value | Description |
| Value | Pixel value at point in image |
| Position | Position of point in image |

FIG. 4 illustrates a line measurement principle to measure distances between pairs of image points. For images with calibrated distance such as CT and MR images or explicitly calibrated RF images, the value is displayed in a metric scale. For non-distance-calibrated images, the value is displayed in pixel co-ordinate units. Interaction is as follows:

1. Move cursor to first point position; Cross Hair cursor is displayed.

2. Click with shift modifier to mark first point in image; pixel-value and position displayed.

3. Move cursor to second point position. Pixel-value and position display removed. Line pullout from first point to cursor and pullout distance displayed. Line pullout and distance updated as cursor is moved.

4. Click to mark second point on image. Line pullout and pullout distance display removed. Line between first and second points and distance measurement displayed.

5. Click to finish interaction.

Options

| | |
|---|---|
| Value | Description |
| Distance | Distance between points |
| Profile | Graph of pixel values along line |

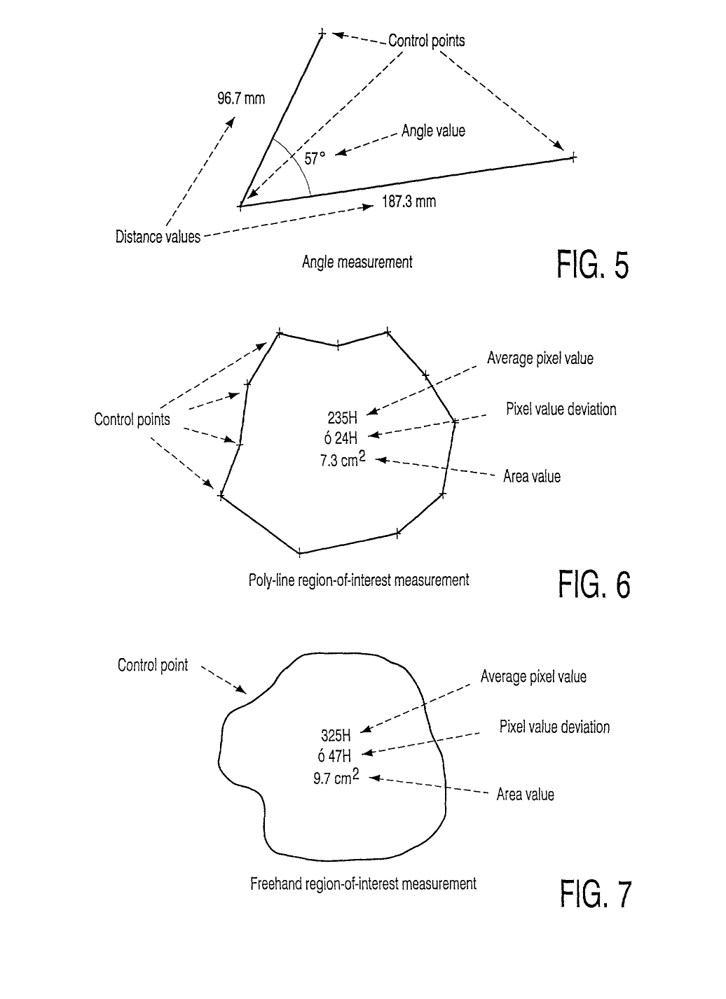

FIG. 5 shows a measurement principle for angle values between connected pairs of lines, and for distances between successive pairs of points on images. Images with known pixel aspect ratio have angle value displayed in degrees. Images with unknown pixel aspect ratio display no angle value. Images wherein distance is calibrated, such as CT and MR images or explicitly calibrated RF images, display distance values in a metric scale. Non-distance-calibrated images display distance values in pixel co-ordinate units. Interaction:

1. Move cursor to first point position; Cross Hair cursor is displayed.

2. Click with shift modifier to mark first point on image: pixel-value and position displayed.

3. Move cursor to second point position. Pixel-value and position display removed. Line pullout from first point to cursor and pullout distance displayed. Line pullout and distance updated as cursor is moved.

4. Click to mark second point on image. Line pullout and pullout distance displays removed. Line between first and second point and distance between first and second point displayed.

5. Move cursor to third point position. Line pullout from second point to cursor, pullout distance and angle between line and pullout displayed. Line pullout, distance and angle updated as cursor is moved.

6. Click to mark third point on image. Line pullout display, pullout distance and pullout angle display removed. Line between second and third point, distance between second and third point, and angle defined by first, second and third points displayed.

7. Click to finish interaction.

Options

| | |
|---|---|
| Value | Description |
| Angle | Angle between lines |
| Distance | Distances between successive points |

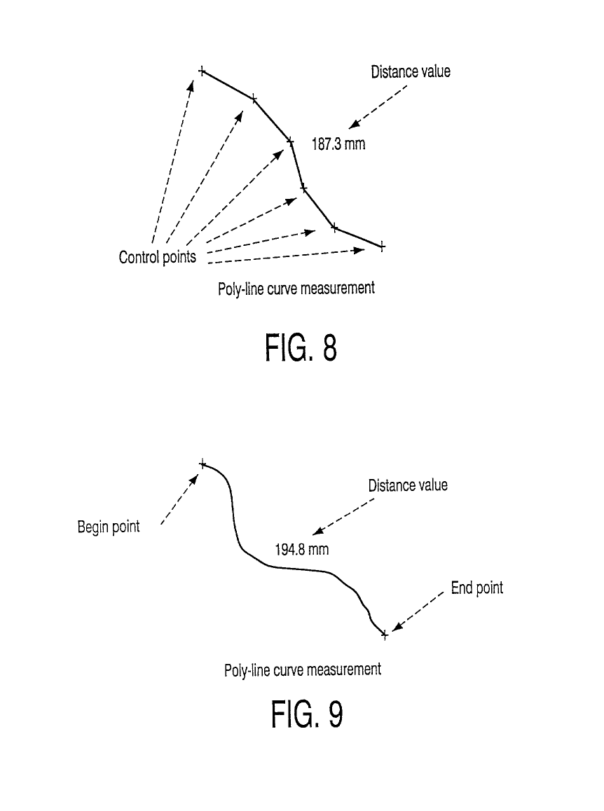

Now, FIG. 6 illustrates a poly-line region-of-interest measurement principle, FIG. 7, a freehand region-of-interest measurement principle, FIG. 8, a poly-line curve measurement principle and FIG. 9, a freehand measurement principle.

In particular, curve measurements measure the distance along a curve drawn over the image. There are two curve forms, a poly-line, that is a series of control points connected by lines, and freehand, wherein begin and end control points are connected by a drawn curve. Defining a series of control points creates the poly-line form.

The freehand form is created by drawing over the required trajectory of the curve. The poly-line from can be edited through the positions of its control points. The freehand form is edited by redrawing portions of the curve.

For images in which distance is calibrated, such as CT and MR images or explicitly calibrated RF images, distance values are displayed in a metric scale. For non-distance-calibrated images, distance values are displayed in pixel co-ordinate units.

Poly-line interaction is as follows:

1. Move cursor to first point position. Cross Hair cursor is displayed.

2. Click with shift modifier to mark first point on image. Pixel-value and position displayed

3. Move cursor to second point position. Pixel-value and position display removed. Line pullout from first point to cursor and pullout distance displayed. Line pullout and distance updated as cursor is moved.

4. Click to mark second point on image. Line pullout display and pullout distance display removed. Line and distance between first and second point displayed.

5. Move cursor to third point position. Line pullout from second point to cursor, pullout distance and angle between line and pullout displayed. Line pullout, distance and angle updated as cursor is moved.

6. Click to mark third point on image. Line pullout display, pullout distance display and pullout angle display removed. Line between second and third point, distance between second and third point and angle defined by first, second and third points displayed.

7. Move cursor to fourth point on image. Both distance displays and angle display removed. Line pullout from third to fourth points displayed.

8. Click to mark fourth point on image. Line pullout display removed. Line between third and fourth points displayed.

9. Move cursor to next point on image. Line pullout from last point to cursor displayed.

10. Click to mark next point on image. Line pullout display removed. Line between previous and last points displayed.

11. Repeat steps 9 and 10 to define all points on curve.

12. Click to finish interaction. Sum of distances between successive curve points displayed.

Freehand interaction is as follows:

1. Move cursor to begin point position. Cross Hair cursor is displayed.

2. Click with control modifier to mark begin point on image.

3. Move cursor over image. Curve is drawn under cursor as cursor is moved.

4. Click to mark end point position. Distance along curve is displayed.

5. Click to finish interaction.

Options

| | |
|---|---|
| Value | Description |
| Distance | Distance along curve |
| Profile | Graph of pixel values along curve |

Region-of-interest measurements determine area and pixel value statistics of a region defined by a closed curve drawn over the image. Just as with curve measurements there are two region-of-interest forms:

| | |
|---|---|
| Form | Description |
| Poly-line | Series of control points connected by lines. |
| Freehand | Control point on drawn contour. |

Defining a series of control points creates the poly-line form. The freehand form is created by drawing over the required trajectory of the region-of-interest contour.

For images in which pixel values are calibrated, such as CT images, pixel value statistics are displayed in the corresponding pixel-value scale. For non-calibrated pixel values, statistics are displayed in pixel code values, often unsigned integer values.

The poly-line from can be edited simply by editing the positions of its control points. The freehand from is edited by redrawing portions of the curve.

For images in which distance is calibrated, such as CT and MR images or explicitly calibrated RF images, area values are displayed in a metric scale. For non-distance-calibrated images, area values are displayed in pixel co-ordinate units.

Poly-line interaction is as follows:

1. Move cursor to first point position. CrossHair cursor is displayed.

2. Click with shift modifier to mark first point on image. Pixel-value and position displayed

3. Move cursor to second point position. Pixel-value and position display removed. Line pullout from first point to cursor, and pullout distance displayed. Line pullout and distance updated as cursor is moved.

4. Click to mark second point on image. Line pullout and pullout distance display removed. Line between first and second point and distance between first and second point displayed.

5. Move cursor to third point position. Line pullout from second point to cursor, pullout distance, and angle between line and pullout displayed. Line pullout, distance and angle updated as cursor is moved.

6. Click to mark third point on image. Line pullout, pullout distance, and pullout angle display removed. Line between second and third point, distance between second and third point, and angle defined by first, second and third points displayed.

7. Move cursor to fourth point on image. Both distances and angle display removed. Line pullout from third to fourth points displayed.

8. Click to mark fourth point on image. Line pullout display removed. Line between third and fourth points displayed.

9. Move cursor to next point on image. Line pullout from last point to cursor displayed.

10. Click to mark next point on image. Line pullout display removed. Line between previous and last points displayed.

11. Repeat steps 9 and 10 to define all points on curve.

12. Move cursor to first point on curve. Line pullout from last point to cursor displayed.

13. Click to close curve and finish interaction. Line pullout display removed. Line between last and first points, and area and pixel value statistics defined by region-of-interest displayed.

Freehand interaction is defined as follows:

1. Move cursor to control point position. Cross Hair cursor is displayed.

2. Click with control modifier to mark control point on image.

3. Move cursor over image. Curve is drawn under cursor as cursor is moved.

4. Move cursor over control point. Curve is closed to form contour of region-of-interest.

5. Click to finish interaction. Area and pixel value statistics for region-of-interest displayed.

Options

| | |
|---|---|
| Value | Description |
| Area | Area of region |
| Average | Average pixel value |
| Deviation | Standard deviation of pixel values |
| Histogram | Histogram of pixel values |
| Maximum | Maximum pixel value |
| Minimum | Minimum pixel value |

Persons skilled in the art will recognize that the above disclosed method may be stored on a data carrier as a computer program that can effect of enhance an existing image processing machine to attain features of the present invention.

1. A method for processing cursored user interaction with a spatially displayed medical image for producing graphics related data on such image,
being characterized in that mouse positionings and/or actuations will control inherent measuring functionalities as being immediately based on relative such positionings with respect to an associated imaged medical object.

2. A method as claimed in claim 1, wherein a single-point actuating/positioning assigns an actual pixel position and/or a pixel intensity quantity to the point in question.

3. A method as claimed in claim 1, wherein a point pair actuating/positioning assigns a distance value to the pair in question.

4. A method as claimed in claim 1, wherein a triple-point actuating/positioning assigns an angle value quantity to a middle point of the triple.

5. A method as claimed in claim 1, wherein multiple-point actuating/positioning for an open or closed point sequence assigns an area value quantity to a concave region delimited by the sequence in question.

6. A method as claimed in claim 1, wherein a freehand-drawn actuating/positioning for an open or closed curve assigns an area value quantity to a concave region delimited by said curve.

7. A method as claimed in claim 1, wherein a multiple-point actuating/positioning for an open or closed sequence assigns a poly-line measurement quantity to the sequence so drawn.

8. A method as claimed in claim 1, wherein a freehand-drawn actuating/positioning for an open or closed sequence assigns a measurement quantity to the freehand sequence so drawn.

9. A method as claimed in any of claims 2 to 8, and furthermore assigning a pixel staticizing to an assigned geometrical entity.

10. An apparatus being arranged for implementing a method as claimed in claim 1, and comprising cursor display means and user interaction means for a spatially displayed medical image for featuring graphics display means for displaying data related to such image,
being characterized by cursor actuating means with detection means for detecting positionings and/or actuations thereof, and drive means for thereupon driving control of inherent measuring functionalities as being immediately based on relative such positionings with respect to an associated imaged medical object.

11. An apparatus as claimed in claim 10, and having assigning means for upon a single-point actuating/positioning assigning an actual pixel position and/or a pixel intensity quantity to the point in question.

12. An apparatus as claimed in claim 10, and having assigning means for upon a point pair actuating/positioning assigning a distance value to the pair in question.

13. An apparatus as claimed in claim 10, and having assigning means for upon a triple-point actuating/positioning assigning an angle value quantity to a middle point of the triple.

14. An apparatus as claimed in claim 10, and having assigning means for upon a multiple-point actuating/positioning for an open or closed point sequence assigning an area value quantity to a concave region delimited by the sequence in question.

15. An apparatus as claimed in claim 10, and having assigning means for upon a freehand-drawn actuating/positioning for an open or closed curve assigning an area value quantity to a concave region delimited by said curve.

16. An apparatus as claimed in claim 10, and having assigning means for upon a multiple-point actuating/positioning for an open or closed sequence assigning a poly-line measurement quantity to the sequence so drawn.

17. An apparatus as claimed in claim 10, and having assigning means for upon a freehand-drawn actuating/positioning for an open or closed sequence assigning a measurement quantity to the freehand sequence so drawn.

18. An apparatus as claimed in any of claims 11 to 17, and having staticizing means for furthermore assigning a pixel staticizing to an assigned geometrical entity.

19. A machine readable computer program, said program being arranged for processing cursored user interaction with a spatially displayed medical image for producing graphics related data on such image, for implementing a method as claimed in claim 1,
said program being characterized by being arranged for sensing mouse positionings and/or actuations and for on the basis thereon effecting inherent measuring functionalities as being based on relative such positionings with respect to a associated imaged medical object, and for subsequently outputting representations of said measuring functionalities for displaying in association with said medical object.
